(19) United States
(12) Patent Application Publication
(10) Pub. No.: US 2025/0172773 A1
(43) Pub. Date: May 29, 2025

(54) DEVICE AND METHOD FOR OPTIMISING THE COUPLING OF A LASER BEAM INTO AN OPTICAL WAVEGUIDE

(71) Applicant: TRUMPF Laser GmbH, Schramberg (DE)

(72) Inventors: Stefan Baumbach, Oberwolfach (DE); Martin Liermann, Villingen Schwenningen (DE)

(21) Appl. No.: 19/036,112

(22) Filed: Jan. 24, 2025

Related U.S. Application Data
(63) Continuation of application No. PCT/EP2023/070663, filed on Jul. 26, 2023.

(30) Foreign Application Priority Data
Jul. 27, 2022 (DE) 10 2022 118 820.5

(51) Int. Cl. G02B 6/42

(52) U.S. Cl. CPC G02B 6/4225

(57) ABSTRACT

A device for optimizing coupling of a laser beam of a laser into an optical waveguide includes a coupler configured to couple the laser beam into the optical waveguide, a mirror device configured to adjust an angle of incidence of the laser beam on the coupler in order to direct the laser beam centrally onto a fiber core of the optical waveguide, a beam offset device configured to adjust a point of incidence on the coupler in order to direct the laser beam perpendicularly onto an inlet surface of the optical waveguide, a sensor configured to detect a measure of a coupling efficiency of the laser beam into the optical waveguide, and a controller configured to receive the measure of the coupling efficiency of the laser beam from the sensor and to send control signals for electronically controllable adjustments of the mirror device and/or the beam offset device.

### CROSS REFERENCE TO RELATED APPLICATIONS

This application is a continuation of International Application No. PCT/EP2023/070663 (WO 2024/023131 A1), filed on Jul. 26, 2023, and claims benefit to German Patent Application No. DE 10 2022 118 820.5, filed on Jul. 27, 2022. The aforementioned applications are hereby incorporated by reference herein.

### FIELD

Embodiments of the present invention relate to a device and a method for optimizing the coupling of a laser beam of a laser into an optical waveguide.

### BACKGROUND

In modern laser systems and in material processing processes in which such laser systems are used, the laser beam generated by the laser beam is often coupled into an optical waveguide in order to transport the laser beam to a target location. The target location can, for example, be a processing optics that shapes the laser beam and then applies the shaped laser beam to a workpiece to be processed, thereby processing the workpiece.

In order to enable optimal transmission of the laser energy through the optical waveguide, it is therefore necessary to ensure optimal coupling of the laser beam into the optical waveguide. The coupling is determined in particular by the angle of incidence of the laser beam and the point of incidence of the laser beam on the coupling device, which transfers the laser beam into the optical waveguide.

A system of two mirrors is typically used to couple the laser beam into an optical waveguide. When the first mirror is exposed to the laser beam and tilted, the position of incidence and angle of incidence of the laser beam on the second mirror changes. However, if the second mirror is then tilted, the angle of incidence and the position of incidence on the subsequent optical element are adjusted again. The position of incidence and the angle of incidence depend on the settings of the first and second angles, because both mirrors adjust both parameters. If, for example, the laser beam strikes an in-coupling optical unit perpendicularly, then a parallel offset of the laser beam is only possible by adjusting both mirrors together. The disadvantage of this is that the interdependent and reciprocal influence of the two mirrors must be compensated for when automatically adjusting the coupling.

DE102016116410 discloses a fiber coupling with a lens and an additional element, which can be a mirror or a prism.

### SUMMARY

Embodiments of the present invention provide a device for optimizing coupling of a laser beam of a laser into an optical waveguide. The device includes a coupler configured to couple the laser beam into the optical waveguide, a mirror device configured to adjust an angle of incidence of the laser beam on the coupler in order to direct the laser beam centrally onto a fiber core of the optical waveguide, a beam offset device configured to adjust a point of incidence, in a form of a parallel offset of the laser beam, on the coupler in order to direct the laser beam perpendicularly onto an inlet surface of the optical waveguide, a sensor configured to detect a measure of a coupling efficiency of the laser beam into the optical waveguide, and a controller configured to receive the measure of the coupling efficiency of the laser beam from the sensor and to send control signals for electronically controllable adjustments of the mirror device and/or the beam offset device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a device for coupling a laser beam into an optical waveguide according to the prior art;

FIG. 2A and FIG. 2B show a schematic representation of the optimization of the coupling of the laser beam;

FIG. 3 shows a schematic representation of the device according to some embodiments;

FIG. 4 shows a schematic representation of the beam offset device according to some embodiments;

FIG. 5 shows a schematic representation of the wedge plate device according to some embodiments;

FIG. 6 shows a further schematic representation of the wedge plate device according to some embodiments; and

FIG. 7 shows a further schematic representation of the device according to some embodiments.

### DETAILED DESCRIPTION

Embodiments of the present invention provide an improved method for optimizing the beam quality.

According to some embodiments, a device for optimizing the coupling of a laser beam of a laser into an optical waveguide is proposed, wherein the device comprises a coupling device that is configured to couple the laser beam into the optical waveguide, wherein the device comprises a mirror device that is configured to adjust the angle of incidence of the laser beam on the coupling device in order to direct the laser beam centrally onto the fiber core of the optical waveguide, wherein the device comprises a beam offset device that is configured to adjust the point of incidence, in the form of a parallel offset of the laser beam, on the coupling device in order to direct the laser beam perpendicularly onto the inlet surface of the optical waveguide.

The optical waveguide is configured to guide the laser beam of the laser, for example the laser beam of an ultrashort pulse laser and/or a high-power laser, from the inlet surface of the optical waveguide to the outlet surface of the optical waveguide. Such an optical waveguide can be, for example, a glass fiber or another suitable fiber. In particular, such an optical waveguide can also be a hollow-core fiber. An optical waveguide also typically has at least one fiber core and a fiber cladding, wherein the light is guided in the fiber core.

In order to couple the laser beam of the laser into the optical waveguide, the laser beam must hit the fiber core of the optical waveguide as centrally as possible. In addition, it is necessary that the laser beam is directed as perpendicularly as possible to the inlet surface of the optical waveguide. This allows a large amount of laser energy to be coupled into the optical waveguide.

Centrally can mean that the laser beam hits the geometric center of the fiber core, for example the center of a fiber core with a round cross-section. However, centrally can also mean that the laser beam hits the surface center of a fiber core cross-section. However, centrally can also mean that the laser beam hits a particular point of symmetry in the fiber core cross-section, for example the focal point of an elliptical fiber core cross-section.

In multi-clad fibers, several fiber cores are distributed in concentric rings about a central fiber core. Each of the ring-shaped fiber cores can be centrally impacted by the laser if, for example, the laser beam hits the center of the ring segment in the radial direction.

For this reason, a mirror device is used to couple the laser beam into the optical waveguide. The mirror device can, for example, comprise one or more mirrors that can deflect the laser beam in different directions. This allows the laser beam to be deflected by the laser in such a way that it is directed as perpendicularly and centrally as possible onto the coupling device, so that the laser beam also enters the inlet surface of the optical waveguide perpendicularly and centrally.

For example, a first mirror can deflect the laser beam in a first axis by a first angle and in a second axis by a second angle. By deflecting the laser beam reflected at the first mirror by a certain deflection angle, a certain point of incidence on the second mirror is defined after propagation to the second mirror. From this point of incidence, the second mirror can, for example, redirect the laser beam reflected at the first mirror in a further first axis by a further first angle and redirect it in a further second axis by a further second angle.

The laser beam reflected at the second mirror is finally coupled indirectly into the optical waveguide via the coupling device, for example a lens. In the plane of the coupling device, what is termed the coupling plane, a point of incidence is then defined as the location at which the laser beam falls on the coupling device. In the coupling plane, the angle of incidence is also defined as the angle of the laser beam relative to the surface normal of the coupling plane. The coupling device and the coupling plane can be used synonymously to describe the point of incidence and angle of incidence.

To optimize the coupling, a beam offset device is arranged between the mirror device and the coupling device.

The beam offset device is preferably configured to adjust the point of incidence in the form of a parallel offset of the laser beam. A parallel offset is a displacement of the incoming laser beam by a certain displacement length. However, the displaced laser beam remains aligned in parallel to the incoming laser beam. In other words, the beam offset device is configured so that no additional angular offset is applied to the laser beam. Instead, the parallel offset can be adjusted without angular offset.

This has the advantage that a degree of freedom can be adjusted in isolation via the beam offset device so that there is no interaction with the mirror device, i.e., the location adjustment does not require angular compensation. For example, the mirror device can orient the laser beam exactly perpendicular to the coupling plane, while the beam offset device adjusts the point of incidence of the laser beam in the coupling plane in isolation.

The beam offset of the beam offset device depends on the relative orientation of the beam offset device to the laser beam. The beam offset o is given by

$$o = \frac{d sin ( α - β )}{cos ( β )} ,$$

wherein α the angle of incidence is relative to the surface normal of the beam offset device, β is the angle of refraction of the beam offset device and d is the thickness of the beam offset device. The angle of refraction results in particular from the refractive indices of air and the material of the beam offset device according to Snell's law of refraction. By tilting or pivoting the beam offset device, the angle of incidence is changed, resulting in a changed deflection.

Consequently, by controlling such a tilt, a drift of the laser beam, for example due to fluctuations in the ambient temperature, can be compensated for easily. For this purpose, for example, the angle of incidence on the coupling device can be adjusted using the last mirror of the mirror device, while the point of incidence on the coupling device is adjusted using the beam offset device.

The coupling device can convert a point of incidence of the laser beam on the coupling device into an angle of incidence of the laser beam on the inlet surface of the optical waveguide and convert an angle of incidence of the laser beam on the coupling device into a point of incidence of the laser beam on the inlet surface of the optical waveguide, wherein the coupling device is preferably a lens or a lens system.

The coupling device is therefore able to perform a position-to-angle transformation or an angle-to-position transformation.

This means that the point of incidence on the coupling device determines the angle of incidence of the laser beam on the inlet surface of the optical waveguide, while an angle of incidence on the coupling device determines a point of incidence on the inlet surface of the optical waveguide. In an ideal system, when the laser beam is on the optical axis of the coupling device, the laser beam also hits the fiber core centrally and hits the inlet surface of the optical waveguide perpendicularly, so that an effective coupling into the inlet surface of the optical waveguide is possible.

The point of incidence on the fiber core of the optical waveguide can deviate by less than 10%, preferably by less than 3%, of the beam diameter of the laser beam from the center of the fiber core of the optical waveguide.

For example, the laser beam can have a beam radius of 30 μm, so that the point of incidence deviates by less than 3 μm, preferably by less than 1 μm, from the center of the fiber core of the optical waveguide.

The angle of incidence on the inlet surface of the optical waveguide can deviate by less than 10%, preferably by less than 3%, of the beam divergence from the perpendicular incidence on the inlet surface of the optical waveguide.

For example, the beam divergence of the laser beam can be 100 μ°, so that the angle of incidence can deviate by less than 10 μ°, preferably by less than 3 μ°, from the perpendicular incidence on the inlet surface of the optical waveguide.

The beam offset device can be a plane-parallel plate. A plane-parallel plate is a plate made of a material with a material-dependent refractive index whose front and back sides are aligned to be parallel to each other. Plane-parallel plates have the advantage that they are easy and inexpensive to produce.

However, the beam offset device can also be a wedge plate device, wherein the wedge plate device comprises two wedge plates which are displaceable relative to one another and wherein the outer sides of the wedge plate device are plane-parallel to one another.

A wedge plate has a thick end which tapers towards a pointed side. The two wedge plates are oriented to each other in such a way that the tapered side of one wedge plate coincides with the thick end of the other wedge plate. The two outer sides of the wedge plate device are those sides of the wedge plates that do not face each other. If these two outer sides are parallel to each other, then the effect of the wedge plate device corresponds to that of a plane-parallel plate. In particular, however, the displaceable wedges can be used to adjust the thickness of the wedge plate device that acts on the laser beam. This provides another possibility to adjust the size of the parallel offset in isolation.

The thickness of the beam offset device can be less than 20 mm, preferably less than 10 mm. The parallel offset of the laser beam on the coupling device can be up to 0.5 mm or up to 1 mm.

This has the advantage that the parallel offset can be adjusted within a sufficiently large range. If the thickness of the beam offset device is larger, the absorption in the material increases such that the laser energy deposited in the beam offset device can damage the beam offset device.

The optical waveguide can be a hollow-core fiber.

Hollow-core fibers have the advantage that the interaction of the laser beam with the fiber material is lower than with conventional glass fibers based on total reflection. This makes it possible, for example, to realize longer optical waveguide lengths. In addition, the magnitude of non-linear effects in the hollow-core fiber is reduced, which means more power can be transported through the hollow-core fiber than through conventional glass fibers.

The mirror device and/or the beam offset device can have an electronically controllable adjustment and a control device, wherein the control device is configured to control the electronically controllable adjustment and the electronically controllable adjustment is configured to adjust the angle of incidence of the laser beam on the coupling device and/or to adjust the point of incidence, in the form of a parallel offset of the laser beam, on the coupling device.

An electronically controllable adjustment can, for example, be a stepping motor or a piezo adjustment. Stepping motor controls have the advantage that they can adjust the mirror device and/or the beam offset device to a large extent. This has the advantage, in particular for the mirror device, that a rough adjustment of the coupling of the laser beam into the optical waveguide is possible. The piezo adjustment has the advantage that it is suitable for precision adjustment. Accordingly, the piezo adjustment can be used, for example, for the beam offset device to adjust the parallel offset with particular precision so that the coupling is optimal. However, a piezo adjustment can also be used in the mirror device, for example to ensure a perpendicular incidence of the laser beam into the inlet surface of the optical waveguide. Both the mirror(s) of the mirror device and the beam offset device can have two electronically controllable adjustments, so that, for example, a tilt in the x-direction can be realized with the first adjustment and in the y-direction with the second adjustment. The device can comprise a sensor device which is configured to detect a measure of the coupling efficiency of the laser beam into the optical waveguide, wherein the sensor device is preferably a photodiode.

With such a sensor device, for example, the intensity can be measured as a measure of the coupling efficiency of the laser light, wherein there is a good coupling with a high intensity. The sensor device can in particular be a photodiode to measure the intensity of the laser beam.

However, it is also possible that the sensor device is a camera, in particular a beam profile camera, which not only measures the intensity of the laser beam, but also detects localized information about the shape and form of the laser beam as a measure of the coupling efficiency.

For this purpose, the device can comprise a beam splitter which is arranged behind the outlet surface of the optical waveguide and is configured to split off a part of the laser beam behind the optical waveguide and to deliver it to the sensor device.

The beam splitter can be configured to split off only a small part of the laser beam out-coupled from the optical waveguide and deliver it to the sensor device. For example, less than 20%, preferably less than 5% of the out-coupled laser beam can be split off.

However, it is also possible for the device to comprise a reflective element on the outlet surface of the optical waveguide, which is configured to reflect a portion of the laser beam back to the inlet surface of the optical waveguide and to deliver it to the sensor device.

The reflective element can, for example, be a partially reflective coating on the outlet surface of the optical waveguide. The reflective element can also be a partially reflective coating on a part of the outlet surface of the optical waveguide.

By partially reflecting the laser beam at the outlet surface of the optical waveguide and passing it through the optical waveguide again, the sensor device can be arranged at the stationary end, or on the laser side, of the optical waveguide. This allows the optical waveguide to be used flexibly and in a space-saving manner on the other side, for example the side of the processing optics.

The device may comprise a control device which is configured to receive the measure of the coupling efficiency of the laser beam from the sensor device and to send control signals to the electronically controllable adjustments of the mirror device and/or beam offset device.

A control device can in particular be a computer and/or a microcontroller and/or an FPGA. If the control device receives the measure of the coupling efficiency and sets the adjustment of the mirror device and/or beam offset device, the measure of the coupling efficiency can be optimized fully automatically. In particular, a change in the measure of the coupling efficiency can be detected and compensated by making adjustments accordingly. This makes it possible to keep the measure of the coupling efficiency at a high level.

The control device can be configured to control only a single mirror and the wedge plate device for optimizing the coupling.

This makes it advantageous to adjust the point of incidence and angle of incidence independently of each other, so that in particular a simplified optimization of the coupling is possible, since no mutual dependencies have to be taken into account when optimizing the point of incidence and angle of incidence.

The above object is also achieved by a method according to the present invention.

Accordingly, a method for optimizing the coupling of a laser beam of a laser into an optical waveguide is proposed, wherein, in a first step, the angle of incidence of the laser beam is adjusted on a coupling device with a first mirror of a mirror device in order to direct the laser beam centrally onto the fiber core of the optical waveguide, wherein, in a second step, a point of incidence, in the form of a parallel offset of the laser beam, is adjusted on a coupling device with a beam offset device in order to direct the laser beam perpendicularly onto the inlet surface of the optical waveguide, and wherein the laser beam is coupled into the inlet surface of the optical waveguide by the coupling device.

In the first step, the beam offset device can be aligned in the beam path such that it does not generate a parallel offset of the laser beam and/or the beam offset device can be oriented in a reference position, wherein the beam offset device is parallel to the coupling device.

For example, a rough adjustment of the mirror device can be carried out and fixed during the production of the laser system, since the adjustment is unsuitable and/or complex for the end user due to the mutual dependencies of the optical components in the laser system. In particular, the angle of incidence of the laser beam can be adjusted during production so that it is perpendicular to the inlet surface of the optical waveguide. To optimize the coupling of the laser beam, it is then only necessary to adjust the angle of incidence using a single mirror and to adjust the parallel offset using the beam offset element.

For example, the beam offset device can be brought into a zero position or reference position and the angle of incidence can be adjusted using the last mirror of the mirror device. The beam offset position can then be tilted from its zero or reference position to create a parallel offset.

The measure of the coupling efficiency of the laser beam into the optical waveguide can be detected with a sensor device and sent to the control device, the control device can receive and analyze the degree of coupling efficiency and send a control signal to electronically controllable adjustments of the mirror device and/or the beam offset device, whereby the angle of incidence and/or the point of incidence in the form of a parallel offset of the laser beam can be adjusted.

For example, the control device detects a lower measure of the coupling efficiency than at an earlier point in time. Then, the control device can send a control signal to the beam offset device so that the beam offset device is tilted by a certain amount in one direction so that a parallel offset by a certain amount in that direction occurs. If no improvement in the measure of the coupling efficiency is subsequently detected, tilting in the opposite direction can occur. If an improvement is detected, a further tilt can be adjusted in a further step to achieve a further improvement in the measure of the coupling efficiency. However, if no improvement is detected, the previous tilt can be adjusted. Subsequently, for example, the tilt can be adjusted in another direction and thus the coupling efficiency can be further increased, or maintained at the high level.

The same steps can be taken, for example, with the last mirror of the mirror device in order to optimize the angle of incidence and increase the measure of the coupling efficiency. Since the parallel offset and the angle of incidence can be adjusted independently of each other, a simple optimization of the coupling is possible, since no mutual dependencies have to be taken into account in an optimization algorithm or an optimization procedure.

The coupling efficiency can thus be adjusted by a control loop, whereby a reading of the measure of the coupling efficiency is carried out for each change in an adjustment, and then a further change in the adjustment is carried out according to the changed measure of the coupling efficiency.

The method can be carried out in particular during ongoing laser operation and can thereby compensate for angular drift and parallel drift of the laser beam, and keep the coupling of the laser beam optimal during ongoing laser operation.

In particular, it provides an automated method for readjusting the measure of the coupling efficiency to ensure the best system performance.

Preferred exemplary embodiments are described below with reference to the figures. In this case, elements that are the same, similar or have the same effect are provided with identical reference symbols in the different figures, and a repeated description of these elements is omitted in some instances in order to avoid redundancies.

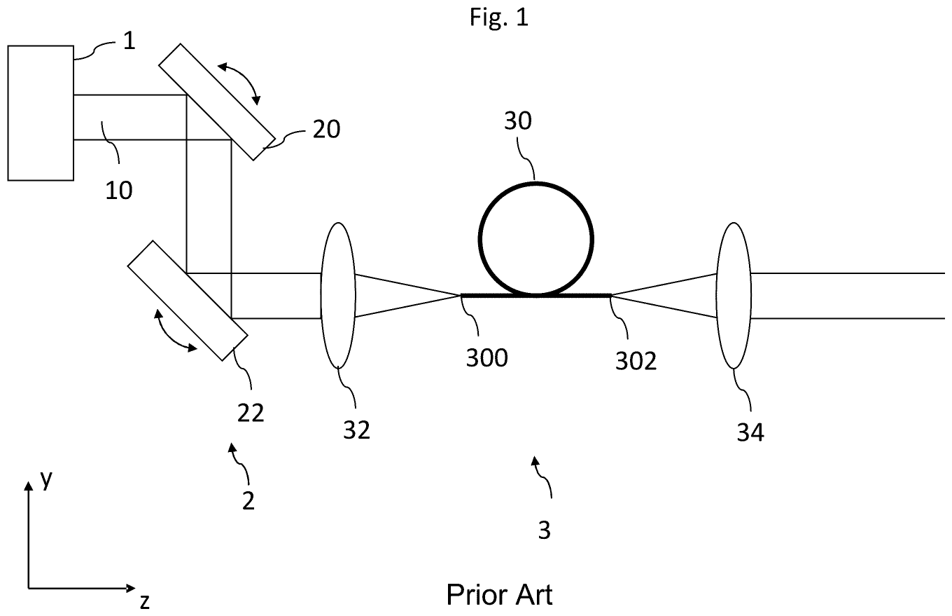

FIG. 1 schematically shows a device for coupling a laser beam 10 of a laser 1 into an optical waveguide 30 according to the prior art. The laser beam 10 is provided by a laser 1, for example an ultrashort pulse laser. The laser beam 10 is then deflected via a mirror device 2 such that it can be coupled into the inlet surface 300 of an optical waveguide 30 using a coupling device 32. The mirror device 2 here has, for example, two mirrors 20, 22.

The first mirror 20 reflects the laser beam 10 in the negative y-direction, where it hits the second mirror 22 after a certain distance. The reflection angle of the first mirror 20 and the distance between the first mirror 20 and the second mirror 22 define a point of incidence of the laser beam 10 on the second mirror 22. From the point of incidence on the second mirror 22, the laser beam 10 is directed in the direction of the optical waveguide 30, where it is coupled into the inlet surface 300 of the optical waveguide 30 by a coupling device 32, for example a lens. After passing through the optical waveguide 30, the laser beam 10 can finally be out-coupled from the outlet surface 302 of the optical waveguide 30 by an out-coupling optical unit 34.

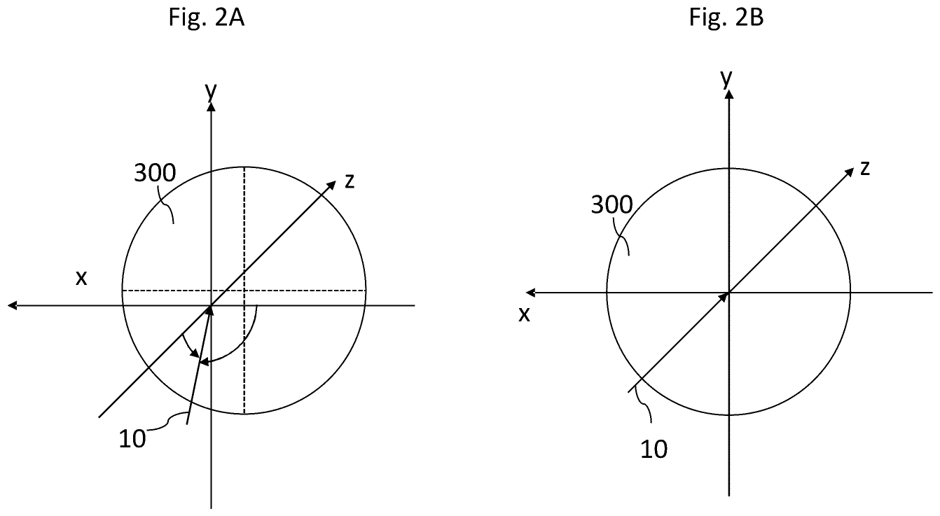

In order to achieve the best possible coupling, the laser beam 10 must hit centrally on the fiber core of the optical waveguide and perpendicularly on the inlet surface 300 of the optical waveguide 30, as shown in FIGS. 2A, B.

FIG. 2A shows the situation in which the laser beam 10 falls on the inlet surface 300 at an angle, for example at an angle pair relative to the x-y plane and relative to the y-z plane. Here, the angle of incidence of the laser beam 10 is measured relative to the surface normal of the inlet surface 300. The point of incidence of the laser beam 10 on the fiber core can also be defined in the inlet surface 300. In the situation shown in FIG. 2A, the inlet surface 300 and the fiber core completely overlap, and the laser beam 10 is directed non-centrally and at an angle onto the inlet surface 300. This results in the laser beam being coupled into the optical waveguide by the coupling device with only little or no efficiency.

In order to achieve the best possible coupling, both the angle of incidence and the point of incidence on the coupling device 32 must be adjusted via the mirror device 2 according to the prior art. However, due to the mirrors used, both sizes can only be adjusted at the same time. FIG. 2B shows the situation of an optimized coupling of the laser beam 10 through the coupling device 32 into the optical waveguide 30, wherein the angle of incidence relative to the surface normal of the inlet surface 300 disappears and wherein the point of incidence of the laser beam 10 coincides with the center of the inlet surface 300, or with the fiber core.

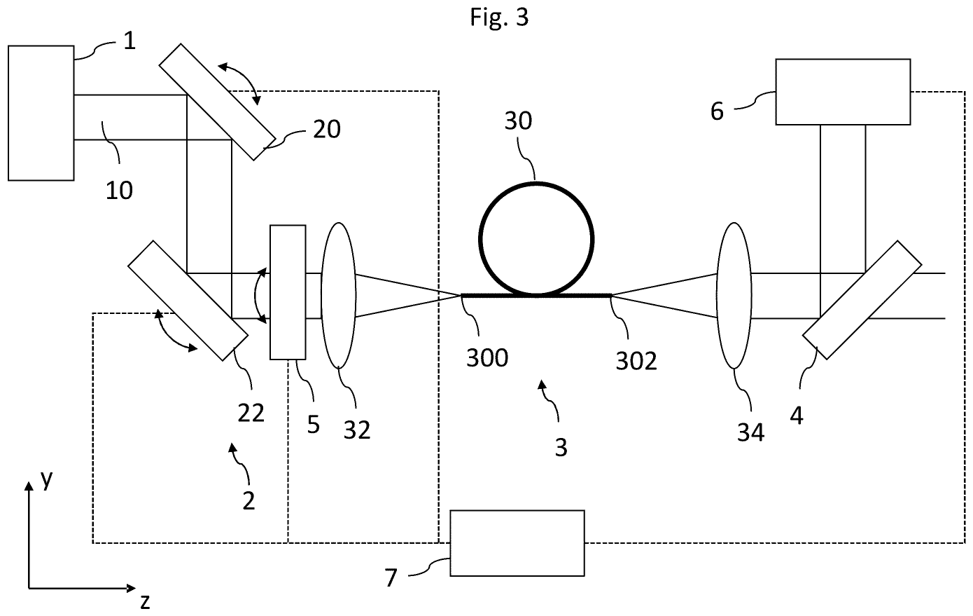

Starting from the ideal situation in FIG. 2B, a drift of the laser beam 10 can occur during laser operation. This drift can, for example, be a drift of the angle of incidence or a drift of the point of incidence. In order to achieve an optimized coupling and to compensate for possible drifts, according to embodiments of the invention a beam offset element 5 is arranged between the mirror device 2 and the in-coupling optical unit 32, as shown in FIG. 3.

The beam offset element 5 is configured to apply a parallel offset to the laser beam 10. By means of a parallel offset, the point of incidence of the laser beam 10 on the coupling device can be adjusted independently of the angle of incidence. This enables an optimized coupling of the laser beam 10.

For example, the laser beam 10 may exhibit a drift in the angle of incidence and the point of incidence after a certain period of operation. By adjusting, for example, the second mirror 22 of the mirror device 2, the point of incidence on the fiber core can be easily corrected. Finally, the subsequent beam offset element 5 can be used to adjust the angle of incidence with a parallel offset of the laser beam 10 in front of the in-coupling optical unit 32, so that the laser beam 10 is directed perpendicularly onto the inlet surface 300 and is thereby coupled into the center of the inlet surface 300 of the optical waveguide 30.

The coupling device 32 can hereby convert a point of incidence of the laser beam 10 on the coupling device 32 into an angle of incidence of the laser beam 10 on the inlet surface 300 of the optical waveguide 30 and convert an angle of incidence of the laser beam 10 on the coupling device 32 into a point of incidence of the laser beam 10 on the inlet surface 300 of the optical waveguide 30, wherein the coupling device 32 is preferably a lens or a lens system.

The point of incidence on the inlet surface 300 of the optical waveguide 30 can deviate by less than 10%, preferably by less than 3%, of the beam diameter of the laser beam 10 from the center of the inlet surface 300 of the optical waveguide 30 and thus also from the center of the fiber core.

For example, the laser beam 10 can have a beam radius of 1 μm, so that the point of incidence deviates by less than 0.1 μm, preferably by less than 0.033 μm, from the center of the fiber core of the optical waveguide 30.

The angle of incidence on the inlet surface of the optical waveguide can deviate by less than 10%, preferably by less than 3%, of the beam divergence from the perpendicular incidence on the inlet surface of the optical waveguide.

For example, the beam divergence of the laser beam can be 600 μ°, so that the angle of incidence can deviate by less than 60 μ°, preferably by less than 18 μ°, from the perpendicular incidence on the inlet surface 300 of the optical waveguide 30.

The mirrors 20, 22 of the mirror device 2 and also the beam offset assembly 5 can be equipped with electronically controllable adjustments so that the tilting of these elements, indicated by the double arrows, can be adjusted electronically. Furthermore, the device has a sensor device 6 and a beam splitter 4, which in this embodiment are both arranged on the side of the out-coupling optical unit 34. The beam splitter 4 can deflect a part of the out-coupled laser beam 10 and provide it to the sensor device 6. A measure of the coupling efficiency can be determined by the intensity measured there or by the beam profile measured there or the beam quality measured there. The sensor device 6 sends the measure of the coupling efficiency to the control device 7. Finally, the control device 7 can control the electronically controllable adjustments of the mirrors 20, 22 and the beam offset device 5 by electronic control. This allows the mirrors 20, 22 and the beam offset device 5 to be tilted and the coupling to be optimized.

For this purpose, the control device 7 can, for example, tilt the last mirror 22 of the mirror device 2 and the beam offset device 5 one after the other. In particular, the control device can be configured to control only a single mirror 22 and the wedge plate device for optimizing the coupling.

By determining the measure of the coupling efficiency after each adjustment, the control device 7 can conclude, by comparing it with the previously measured value, whether the coupling has been improved or worsened or whether the coupling has remained the same. The coupling efficiency can be optimized by systematically adjusting the tilts.

For example, in a first step, only the angle of incidence of the laser beam 10 in the coupling plane can be adjusted, by arranging the beam offset device 5 in the beam path such that the parallel offset is zero. However, it is also possible for the beam offset device 5 to be moved into a reference position, for example to be parallel to the coupling plane. As a result, the angle of incidence of the laser beam 10 on the beam offset device 5 corresponds to the angle of incidence of the laser beam 10 on the coupling plane. Subsequently, the parallel offset of the laser beam 10 can be adjusted by tilting the beam offset device 5 so that the laser beam 10 perpendicularly hits the inlet surface 300 of the optical waveguide 30.

For example, it is possible to achieve a fully automatic optimization of the coupling of the laser beam 10 during ongoing laser operation. This allows temporal drifts, such as angular drifts or parallel drifts, to be compensated.

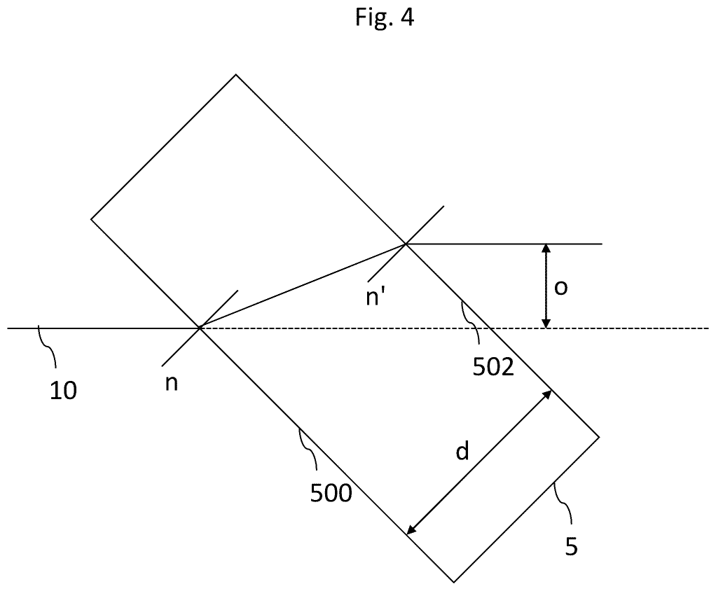

FIGS. 4, 5 and 6 show various possible embodiments of the beam offset device 5. In FIG. 4, the beam offset device 5 is a plane-parallel plate. A plane-parallel plate has two plane-parallel outer surfaces 500, 502 through which the laser beam 10 penetrates. If the laser beam 10 enters the plane-parallel plate 5 through the outer surface 500 at an angle of incidence to the surface normal n, then the laser beam 10 is refracted to the surface normal n. When the laser beam 10 exits the plane-parallel plate, the laser beam 10 is refracted away from the surface normal n′. As a result, the outgoing laser beam only has a parallel offset o to the incoming laser beam. The parallel offset o depends on the input angle relative to the surface normal n, as well as on the thickness D of the plane-parallel plate.

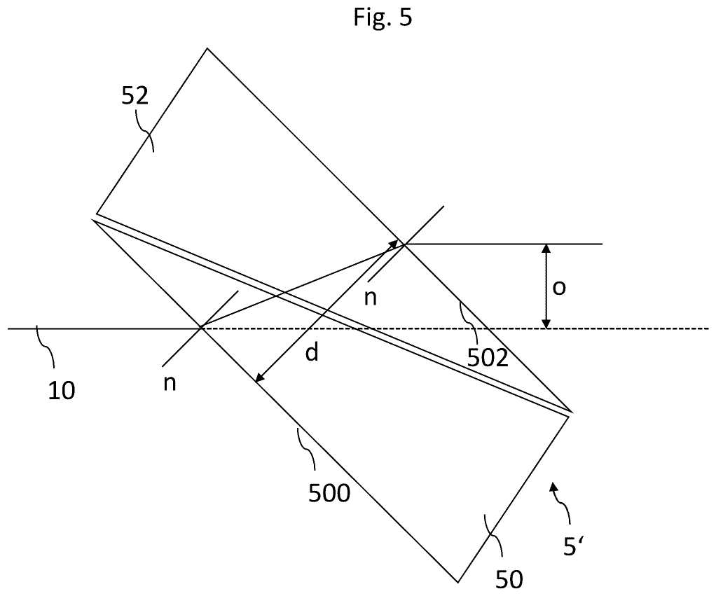

FIG. 5 shows an alternative embodiment of the beam offset device 5. The beam offset device 5 is a wedge plate device 5′. The wedge plate device 5′ comprises two wedge plates 50, 52, which taper from a thick end to a tapered side. The two wedge plates 50, 52 are placed and/or oriented against each other in such a way that the outer surfaces 500, 502 and also the inner surfaces run parallel to each other. Accordingly, a parallel offset o can also be generated with a wedge plate device 5′.

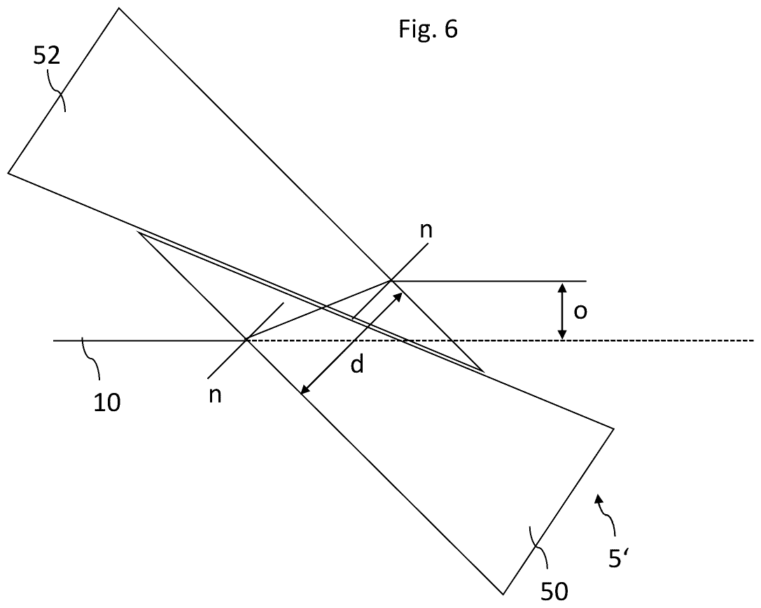

The two wedges 50, 52 of the wedge plate device 5′ can be displaced relative to each other, as shown in FIG. 6. This makes it possible to adjust the thickness of the wedge plate device 5′, through which the laser beam 10 is displaced in parallel. If the wedge plates 50, 52 are displaced relative to each other, the thickness d becomes smaller, whereby the parallel offset o also becomes smaller. If the wedge plates 50, 52 are pushed on top of each other, the thickness d becomes larger, whereby the parallel offset o also becomes larger.

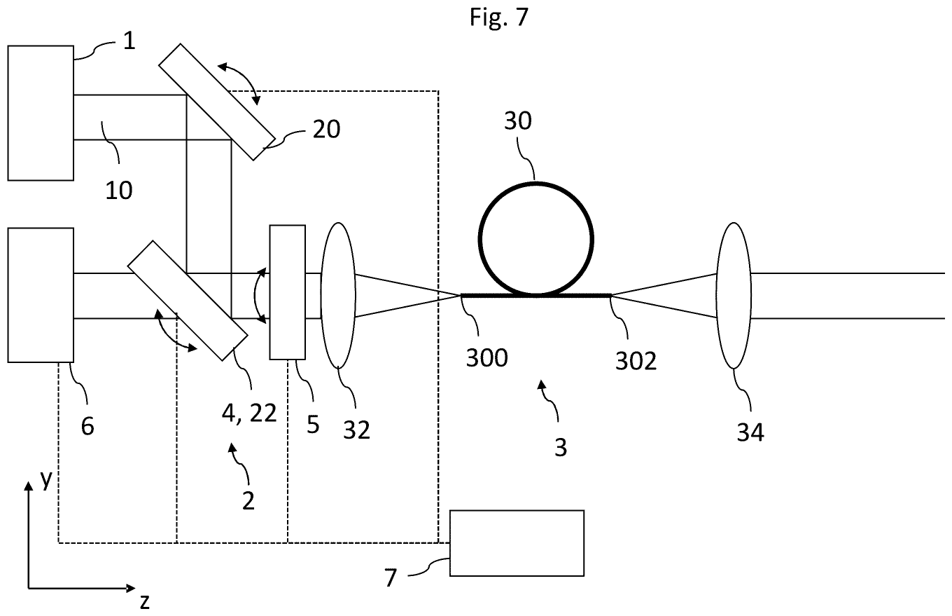

FIG. 7 shows a further embodiment of the device. Here, the outlet surface 302 of the optical waveguide 30 has at least partially a partially reflective coating which reflects the laser beam 10 back to the inlet surface 300 of the optical waveguide 30. The outlet surface 302 of the optical waveguide 30 in particular also comprises further components which are attached to the fiber end of the optical waveguide 30. For example, a so-called end cap can be spliced or fused onto a fiber end, which has such a coating. For example, at a fiber end of a hollow-core fiber, a glass block can be held at a distance from the fiber end via a ferrule and a nozzle brick, wherein the glass block, in particular a glass block made of quartz glass, can have such a coating. The use of a hollow-core fiber with a coated glass block is preferred when using ultrashort laser pulses. The laser beam out-coupled from the outlet surface 302 can, for example, be deflected by a beam splitter 4 and delivered to the sensor device 6. This embodiment has the advantage that the detection of the measure of the coupling efficiency is arranged on the stationary side, i.e., the laser side of the device. As a result, the optical waveguide 30 can be used flexibly without, for example, the need for installation space for a beam splitter 4 and a sensor device 6 on the side of a processing optics.

Insofar as applicable, all individual features presented in the exemplary embodiments may be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Laser
10 Laser beam
2 Mirror device
20 First mirror
22 Second mirror
3 Optical waveguide device
30 Optical waveguide
32 Coupling optical unit
34 Decoupling optical unit
300 Inlet surface
302 Outlet surface
4 Beam splitter
5 Beam offset device
5′ Wedge plate device
50 First wedge
52 Second wedge
6 Sensor device
7 Control device
d Thickness of the beam offset device
o Parallel offset
n, n′ Surface normal

1. A device for optimizing coupling of a laser beam of a laser into an optical waveguide, the device comprising:
a coupler configured to couple the laser beam into the optical waveguide,
a mirror device configured to adjust an angle of incidence of the laser beam on the coupler in order to direct the laser beam centrally onto a fiber core of the optical waveguide, a beam offset device configured to adjust a point of incidence, in a form of a parallel offset of the laser beam, on the coupler in order to direct the laser beam perpendicularly onto an inlet surface of the optical waveguide,
a sensor configured to detect a measure of a coupling efficiency of the laser beam into the optical waveguide, and
a controller configured to receive the measure of the coupling efficiency of the laser beam from the sensor and to send control signals for electronically controllable adjustments of the mirror device and/or the beam offset device.

2. The device according to claim 1, wherein the beam offset device is configured to adjust the point of incidence, in the form of the parallel offset of the laser beam, without changing the angle of incidence.

3. The device according to claim 1, wherein the coupler is configured to convert a point of incidence of the laser beam on the coupler into an angle of incidence of the laser beam on the inlet surface of the optical waveguide, and convert the angle of incidence of the laser beam on the coupler into a point of incidence of the laser beam on the fiber core of the optical waveguide.

4. The device according to claim 3, wherein the coupler comprises a lens or a lens system.

5. The device according to claim 1, wherein a point of incidence of the laser beam on the fiber core of the optical waveguide deviates by less than 10% of a beam diameter of the laser beam from a center of the fiber core of the optical waveguide, and/or an angle of incidence of the laser beam on the inlet surface of the optical waveguide deviates by less than 10% of a beam divergence from a perpendicular incidence on the inlet surface of the optical waveguide.

6. The device according to claim 1, wherein the beam offset device comprises
a plane-parallel plate, or
a wedge plate device, wherein the wedge plate device comprises two wedge plates displaceable relative to one another, and wherein outer sides of the wedge plate device are plane-parallel to one another.

7. The device according to claim 1, wherein a thickness of the beam offset device is less than 20 mm.

8. The device according to claim 1, wherein the parallel offset of the laser beam on the coupler is up to 1 mm.

9. The device according to claim 1, wherein the optical waveguide comprises a hollow-core fiber or a multi-clad fiber.

10. The device according to claim 1, wherein the controller is configured to control the electronically controllable adjustment of the mirror device and/or the beam offset device, and the electronically controllable adjustment is configured to adjust the angle of incidence of the laser beam on the coupler and/or to adjust the point of incidence, in the form of the parallel offset of the laser beam, on the coupler.

11. The device according to claim 1, further comprising
a beam splitter arranged downstream from an outlet surface of the optical waveguide and configured to split off a part of the laser beam downstream of the optical waveguide and deliver the part of the laser beam to the sensor, and/or
a reflective element on the outlet surface of the optical waveguide, the reflective element configured to reflect a part of the laser beam back to the inlet surface of the optical waveguide and deliver the part of the laser beam to the sensor.

12. The device according to claim 1, wherein the controller is configured to control a single mirror of the mirror device and the beam offset device for optimizing the coupling.

13. A method for optimizing coupling of a laser beam of a laser into an optical waveguide, the method comprising:
adjusting an angle of incidence of the laser beam on a coupler with a first mirror of a mirror device in order to direct the laser beam centrally onto a fiber core of the optical waveguide,
adjusting a point of incidence, in a form of a parallel offset of the laser beam, on the coupler with a beam offset device in order to direct the laser beam perpendicularly onto an inlet surface of the optical waveguide, and
coupling the laser beam into the inlet surface of the optical waveguide by the coupler.

14. The method according to claim 13, wherein, in the adjusting the angle of incidence of the laser beam, the beam offset device is aligned in a beam path such that the beam offset device does not generate a parallel offset of the laser beam, and/or the beam offset device is oriented in a reference position, wherein the beam offset device is parallel to the coupler.

15. The method according to claim 13, further comprising
detecting a degree of coupling efficiency of the laser beam into the optical waveguide with a sensor, and
sending the degree of coupling efficiency to a controller, wherein the controller is configured to receive and analyze the degree of coupling efficiency and send a control signal for electronically controllable adjustments of the mirror device and/or the beam offset device, thereby the angle of incidence of the laser beam on the coupler and/or the point of incidence of the laser beam in the form of the parallel offset of the laser beam on the coupler is adjusted.

16. The method according to claim 13, wherein the method is carried out during ongoing laser operation and thereby compensates for an angular drift and a parallel drift of the laser beam, and optimally maintains the coupling of the laser beam during the ongoing laser operation.
